(19) United States
(12) Patent Application Publication
(10) Pub. No.: US 2004/0139789 A1
(43) Pub. Date: Jul. 22, 2004

(54) Leak tester for an endoscope and associated method

(75) Inventor: Michael Masters, Canton, GA (US)

Correspondence Address: Michael Masters, 219 Moore Valley Way, Canton, GA, 30115, US

(73) Assignee: Master Endoscope LLC

(21) Appl. No.: 10/345,538

(22) Filed: Jan. 16, 2003

(51) Int. Cl. G01M 3/04

(52) U.S. Cl. 73/49.2

(57) ABSTRACT

An apparatus and method for leak testing a lumened instrument, such as an endoscope, utilizes a compressor for pressurizing the interior of the lumened instrument to a predetermined internal pressure and a monitoring device which de-actuates the compressor when the internal pressure reaches the predetermined internal pressure. Calculator circuits calculate any difference in the instrument pressure between the moment that the compressor is de-actuated and the end of a prescribed period of time following the de-actuation of the compressor, and comparison circuits compare the pressure difference to an acceptable range of pressure differentials. A set of pass/fail indicator lights provide a visual indication of whether the compared difference is within or outside of the acceptable range so that an operator can tell by viewing the pass/fail indicator lights whether the instrument being tested has an unacceptable leak.

### BACKGROUND OF THE INVENTION

This invention relates generally to means and methods for testing a lumened medical instrument, such as an endoscope, prior to use and relates, more particularly, to means and methods for testing such an instrument for leaks.

A lumened medical instrument, such as an endoscope, has a hollow interior through which components, such as fiber optic cables, are routed as the instrument is directed through the human body during a medical procedure or examination. In order that the interior of the instrument remains free of contamination and the components which are routed through the instrument are not fouled by body fluids as the instrument is routed through the body, it is important that the instrument be free of leaks. Consequently, the instrument is preferably tested for leaks between uses.

Heretofore, such an instrument has been commonly tested by attaching the instrument to a means for pressurizing the interior of the instrument and then submerging the instrument in a fluid (e.g. a tank of water). By pressurizing the instrument interior while the instrument remains submerged, bubbles will be emitted from any leak in the instrument, thus identifying the site of a leak requiring repair.

Testing methods such as aforedescribed ordinarily require that an individual be present during the testing procedure to monitor the leak test operation. Furthermore and because leaks must be visually detected by an individual, errors can result, and this is particularly true if a leak which is present in the instrument is very small. Further still, such a testing methodology does not, by itself, generate a written record of the test results.

It would be desirable to provide a new and improved apparatus and method for leak testing a lumened medical instrument, such as an endoscope, which does not require that the instrument be submerged or that an individual be present to monitor the instrument throughout the testing operation and which generates a written record of the test results.

Accordingly, it is an object of the present invention to provide a new and improved leak test apparatus for a lumened medical instrument, such as an endoscope, and a method for using the leak test apparatus.

Another object of the present invention is to provide such an apparatus whose testing steps are performed automatically and which does not require monitoring throughout the test procedure.

Still another object of the present invention is to provide such an apparatus which provides a clear visual indication of whether or not the instrument being tested passes a leak test operation.

Yet another object of the present invention is to provide such an apparatus which provides a written record of the leak test results.

A further object of the present invention is to provide such an apparatus which, if necessary, can be used to pressurize, and thus leak test, a lumened medical instrument while the instrument is submerged.

A still further object of the present invention is to provide such an apparatus which is uncomplicated in construction yet effective in operation.

### SUMMARY OF THE INVENTION

This invention resides in an apparatus and method for leak testing a lumened instrument having a hollow interior.

The apparatus of the invention includes means for pressurizing the interior of the lumened instrument to be tested and means for de-actuating the pressurizing means when the internal pressure of the instrument reaches a predetermined internal pressure. Also included are means for computing the difference between the internal pressure of the instrument at the end of a prescribed period of time following the de-actuation of the pressurizing means and at the start of the prescribed period of time wherein the start of the prescribed period of time corresponds with the moment that the pressurizing means is de-actuated. Means are utilized for comparing the computed pressure difference with a range of acceptable pressure differentials and determining whether the computed pressure difference is within or outside of the acceptable range. The apparatus further includes means for providing a visual indication of whether the compared difference is within or outside of the acceptable pressure differential range so that an operator can tell by viewing the visual indication means whether the instrument being tested passes (i.e. is substantially leak-free) or fails the leak test.

The method of the invention includes the steps involved in the operation of the apparatus of the invention. More specifically, such steps include the pressurizing the interior of the lumened instrument to be tested and then discontinuing the pressurizing step when the internal pressure of the instrument reaches a predetermined internal pressure. Then, the difference between the internal pressure of the instrument at the end of a prescribed period of time following the discontinuance of the pressurizing step and at the start of the prescribed period of time is computed wherein the start of the prescribed period of time corresponds with the moment that the pressurizing step is discontinued. The computed pressure difference is compared with a range of acceptable pressure differentials to determine whether the computed pressure difference is within or outside of the acceptable range, and then a visual indication is provided as to whether the compared difference is within or outside of the acceptable pressure differential range.

In particular embodiments of the apparatus and method, a print-out of the leak test results, which printout includes instrument identifying indicia and the time and date of the leak test, is generated for record-keeping purposes.

### BRIEF DESCRIPTION OF THE DRAWINGS

FIG. 1 is a perspective view of a leak test apparatus and an endoscope to which the leak test apparatus is connected.

FIG. 2 is a perspective view of the control box of the leak test apparatus of FIG. 1.

FIG. 3 is a view illustrating in block diagram form the operation of the leak test apparatus of FIG. 1.

### DETAILED DESCRIPTION OF AN ILLUSTRATIVE EMBODIMENT

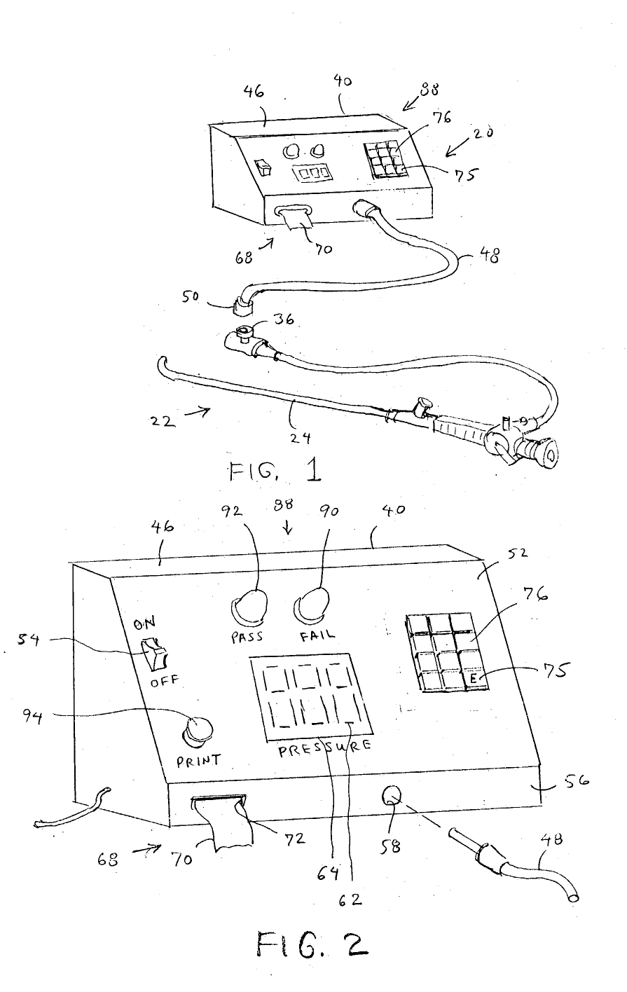

Turning now to the drawings in greater detail, there is shown in FIG. 1 an embodiment, generally indicated 20, of a detector apparatus within which features of the invention are embodied and an example of a lumened medical instrument, generally indicated 22, which is capable of being leak tested with the apparatus 20. The depicted medical instrument 22 is an endoscope including a lengthy (hollow) portion 24 comprised of a series of hollow lumens which are joined together with O-rings and an access (i.e. leak test) port 36 through which the endoscope 22 can be leak tested.

While the apparatus 20 is described herein as being used for leak testing an endoscope 22, other medical instruments having a hollow interior and which are designed to undergo an occasional leak test can also be leak tested with the apparatus 20. Accordingly, the principles of the present invention can be variously applied.

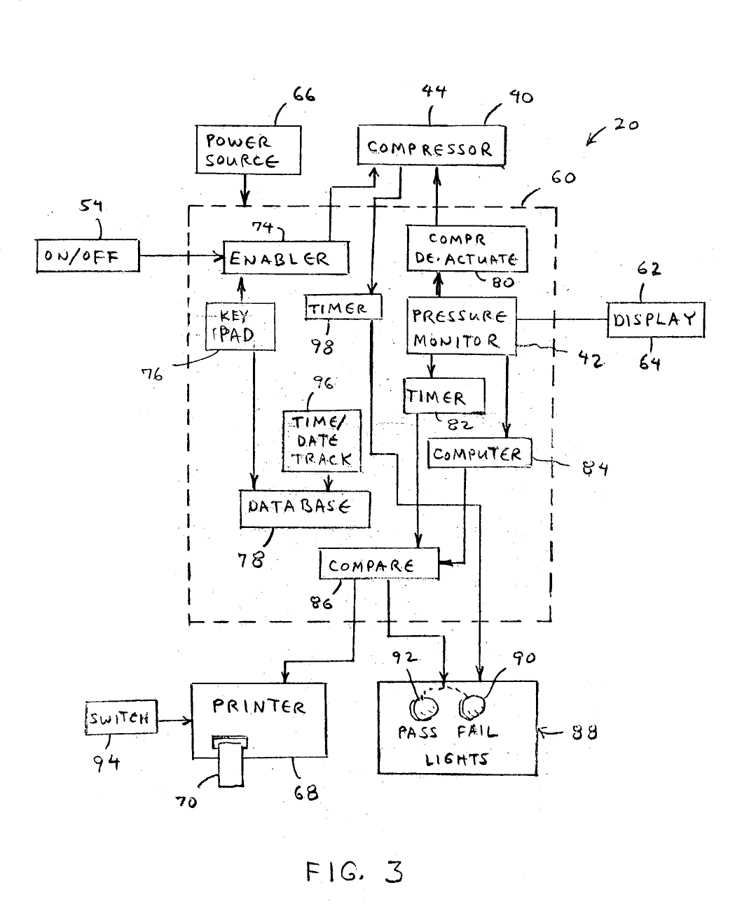

With reference to FIGS. 1-3, the apparatus 20 includes means, indicated 40, for pressurizing the interior of the endoscope 22 to be leak tested and means, indicated 42 in FIG. 3, for monitoring the internal pressure of the endoscope 22 as a leak test is being conducted with the apparatus 20. To this end, the pressurizing means 40 includes an electrically-operated air compressor 44 which is mounted within a control box 46 (FIGS. 1 and 2) and a hose 48 which is connected at one end to the outlet of the compressor 44 (FIG. 3) for connection to the endoscope 22 to be tested. At the end of the hose 48 opposite the compressor 44 is a coupler member 50 (FIG. 1) which is adapted to be sealingly connected to the access port 36. During a leak test operation, the compressor 44 delivers air, under pressure, to the interior of the endoscope 22 by way of the hose 48. Accordingly, the coupler member 50 (which can take the form of a quick-connect fitting) is adapted to be readily coupled to the access port 36 in an air-tight manner in preparation of a leak test operation.

The control box 46 (FIGS. 1 and 2) of the apparatus 20 houses several components of the apparatus 20 and has a front control panel 52 upon which an ON/OFF control switch 54 and viewable displays, described herein, are mounted. For example, the apparatus 20 houses the compressor 44 and control componentry, described herein, with which the operations of the apparatus 20 are controlled. One panel, indicated 56 in FIG. 2, of the control box 52 has an opening 58 through which the end of the hose 48 opposite the coupler member 50 is routed, and that end of the hose 48 is connected to the outlet of the compressor 44 for delivering air, under pressure, to the endoscope 22 by way of the coupler member 50.

The control componentry, indicated 60 in FIG. 3, of the apparatus 20 includes the monitoring means 42, introduced earlier, for monitoring the pressure of the interior of the endoscope 22 and generating signals which correspond with the internal pressure of the endoscope 22. The monitoring means 42 can take the form of a suitable monitoring device, such as a pressure transducer, which is mounted within the control box 46 and connected to the outlet of the compressor 44 for monitoring the pressure within the hose 48 which, in turn, is indicative of the internal pressure of the endoscope 22. As will be apparent herein, the pressure-indicating signals generated by the monitoring means 42 are used in the determination of whether the endoscope 22 passes or fails a leak test performed with the apparatus 20 and for providing an operator with a visual indication of the internal pressure of the endoscope 22 as a leak test is underway.

Along the lines of the foregoing, the apparatus 20 also includes visual display means, indicated 62 in FIGS. 2 and 3, for receiving the pressure-indicating signals generated by the monitoring means 42 and providing a visual indication of the endoscope pressure being monitored by the monitoring means 42. In the depicted embodiment 20, the visual display means 62 includes a light emitting diode (LED) display 64 mounted upon the front of the control box 46 for receiving signals generated by the monitoring means 42 and digitally displaying the value of the pressure of the endoscope 22 in response to the received signals. As an alternative to the LED display 64, an apparatus in accordance with the present invention can include a pressure gauge. In the depicted embodiment 20, the LED display 64 is adapted to display the endoscope pressure in gm/cm², but displays for alternative embodiments can be adapted to display the pressure in alternative units of pressure.

Associated with the apparatus 20 is a power supply 66 which can take the form of a storage battery mounted within the control box 46 or, in the alternative, can include appropriate wiring and associated circuitry enabling the apparatus componentry 60 to be plugged into a standard electrical (e.g. wall) outlet. In either case and as will be apparent herein, electrical power is supplied to the componentry 60 by way of the power supply 66 for supplying operating power to the componentry 60 and the compressor 44.

The apparatus 20 also includes means, indicated 68 in FIGS. 1-3, for printing the details of the leak test results at the completion of a leak test operation and input means including a keypad 76 (embodied within the control box 46 and appropriately connected to the control componentry 60) with which information which identifies the endoscope being tested (e.g. the endoscope serial number) is input by an operator into the control componentry 60. In this connection, the printing means 68 (i.e. a printer) is mounted within the control box 46 and is adapted to dispense a paper printout 70 (FIG. 2) of printed results through an opening 72 provided in the control box panel 56 at the end of a leak test operation, and the control componentry 60 of the apparatus includes a database 68 which stores the input (endoscope identification) information for printing on the printout 70 when the appropriate commands are sent to the printer 68 to print out the leak test results.

It is a feature of the apparatus 20 that even after the apparatus switch 52 is switched ON, the compressor operation is prevented until the identification information relating to the endoscope being tested is input into the control componentry 60 by way of the keypad 76. To this end, the componentry 60 includes enabling means 74 (FIG. 3) wired in-line with the ON/OFF switch 54 and the compressor 44 for preventing the operation of the compressor 44 until the identification information (e.g. the serial number) of the endoscope 20 to be tested is input to the control componentry 60. The enabling means 74 can take the form of a solid state device embodying a pair of switches—one of which is closed only if the ON/OFF switch 54 is switched ON, and other of which is closed only if an endoscope serial number is typed into the control circuitry 60 by way of the keypad 76 and an ENTER key, indicated 75 in FIGS. 1 and 2, of the keypad 76 is subsequently depressed. In any event, the enabling means 74 switches the compressor 44 ON only after the identification information relating to the endoscope to be tested is input into the control componentry 60 where the information is stored in the database 68 until the information is printed on the printout 70 upon completion of a leak test operation.

The operation of the apparatus 20 can best be described with reference to the block diagram of FIG. 3. In particular, upon connecting the coupler member 50 to the endoscope access port 36 and switching the apparatus 20 ON, the identification information relating to the endoscope (e.g. the endoscope serial number) is input to the control componentry 60 by way of the keypad 76. After the endoscope identification information is input into the componentry 60 and the ENTER key 75 of the keypad 76 is depressed, the enabling means 74 initiates the operation of the compressor 44. Upon initiation of the compressor operation, air, under pressure, begins to be delivered to the interior of the endoscope 22 by way of the hose 48. As the internal pressure of the endoscope 22 builds up, the monitoring means 42 monitors the internal pressure of the endoscope 22 and sends appropriate (pressure-indicative) signals to the display means 62 where the actual pressure of the endoscope 22 is displayed on the LED display 64 (FIG. 2).

When the pressure within the endoscope 64 rises to a predetermined pressure level (described herein), the compressor operation is shut off and a timer operation is initiated. To this end, the componentry 60 includes means, indicated 80 in FIG. 3, for de-actuating the compressor 44 when the internal pressure of the endoscope 22 reaches the predetermined level, and the componentry also includes a solid state timer 82 whose operation is initiated upon sensing that the internal pressure of the endoscope 22 has reached the predetermined level (which, of course, corresponds with the moment that the compressor 44 is de-actuated). The de-actuating means 80 can be in the form of a solid-state switch and is adapted to be re-set, for example, by switching the apparatus 20 OFF. In other words, by returning the ON/OFF switch 52 to the OFF position (following the generation of a printout 70 at the end of a leak test operation), the de-actuating means 80 returns, or defaults, to a condition which permits the compressor 44 to again be operated by switching the apparatus 20 ON and entering the endoscope identification information by way of the keypad 76.

The timer 82 begins its operation upon sensing (from the monitoring means 42) that the predetermined endoscope pressure has been reached and generates a signal when a prescribed period of time has passed, as measured from the moment that the compressor 44 is de-actuated. As will be apparent herein, the signal generated by the timer triggers the use of the internal pressure of the endoscope 22 at that moment in calculations performed by the componentry 60.

The apparatus 20 also includes computer means, indicated 84 in FIG. 3, for receiving the pressure-indicating signals from the monitoring means 42 at the end of a predetermined period time (as determined by the timer 82) and performing a computation with the pressure value (or amount) corresponding with that received pressure-indicating signal. In practice, the signal generated by the timer 82 at the end of the prescribed period of time is received by the computer means 84 which, in turn, initiates the collection of the actual pressure of the endoscope 22 (as monitored by the pressure monitoring means 42) at that instant, or moment, in time for use in a subsequent calculation. More specifically, the computer means 84 subtracts the internal pressure of the endoscope 22 collected at the end of the prescribed period of time (i.e. the end of the period as timed with the timer 82) from the internal pressure of the endoscope 22 at the beginning of the predetermined period of time (which, of course, is the predetermined pressure level at which the compressor 44 shuts off) to obtain a resulting calculated difference (or differential) between the endoscope pressure at the beginning of and at the end of the predetermined period of time. As will be apparent herein, if the resulting (computed) pressure difference is within an acceptable pressure differential range (which has been stored, or pre-programmed, into the database 68), then the endoscope 22 passes the leak test, and if the resulting (computed) pressure difference is outside of the acceptable pressure differential range, then the endoscope 22 fails the leak test.

An acceptable range of pressure differentials (which corresponds with a acceptable pressure drop between the beginning and the end of the prescribed period of time) is pre-programmed into the database 68, and the computer means 84 includes comparison circuit 86 for comparing the computed pressure differential (as calculated by the computer means 84) to the pre-programmed acceptable pressure differential. If the computed pressure differential is within a range of acceptable pressure differentials, then a “pass” signal is generated by the comparison circuit 86, and if the computed pressure differential is greater than the acceptable pressure differential, then a “fail” signal is generated. In the interests of the present invention, the phrase “within the range of acceptable pressure differential” means “equal to or less than the acceptable pressure differential”.

The apparatus 20 also includes indicating means, generally indicated 88, for visually indicating the pass/fail results to an operator. In other words, the indicating means 88 is adapted to visually indicate to an operator whether the resulting difference (as calculated by the comparison circuits 86) is within the acceptable pressure differential range, thus indicating that the endoscope 22 passes the test, or whether the resulting difference (as calculated by the comparison circuits 86) is outside of (i.e. is greater than) the acceptable pressure differential range. To this end, the indicator means 88 includes a red-colored light 90 for receiving any “fail” signal generated by the comparison circuit 86 and a green-colored light 92 for receiving any “pass” signal generated by the comparison circuit 86 and capable of being lit up according to the received signal. In addition, each of the red and green lights 90 and 92 is mounted on the front panel 52 of the control box 46 and is appropriately wired to the computer means 84 for receiving the corresponding “pass” or “fail” signal generated by the comparison circuit 86. It follows that immediately following the comparison operation performed by the comparison circuit 86, an operator can tell by looking at the lights 90 and 92 and seeing which light 90 or 92 is lit up, whether the endoscope 22 passes or fails the leak test.

Once the “pass” signal or “fail” signal is generated by the comparison circuit 86 and the corresponding red or green light 90 or 92 has been lit, the printer 68 can then be initiated (by depression of an appropriate printer start switch 94) so that the printer 68 prints a printout 70 for recording the identification information relating to the endoscope being tested and whether the endoscope passes or fails the leak test. Preferably, the control componentry 60 also includes a date tracking and clock circuit 96 for recording on the printout 70 the date and time that the leak test is conducted. To this end, the date tracking and clock circuit 96 continually monitors the actual date and time and is appropriately connected to the printer 68 for sending signals thereto when the printer start switch 94 is depressed.

For example and when it is desired to print the test results (following the completion of a leak test cycle) in a preferred embodiment, the printer start switch 94 is depressed to initiate the operation of the printer 68. Upon depression of the printer switch 94, the printer 68 receives (i.e. collects) the endoscope identification information stored in the database 78, as well as the pass/fail signal from the comparison circuit 86 and the date and time of the test from the tracking circuit 96, and prints onto a paper printout 70 (fed from a roll) the date and time of the test, the endoscope serial number and the test results (i.e. whether the endoscope passes or fails the leak test). Such a printout 70 is dispensed from the printer 68 through the control box opening 72 (FIG. 2) where it can be readily retrieved by an operator.

The paper printout 70 of the test results is advantageous in that it provides a tangible record which can be readily attached or entered into the medical records of the patient to be worked upon with the endoscope 22 being tested. If, for example, and long after a test procedure is performed with the endoscope 22 being tested, there is a question whether the endoscope 22 was leak tested before being used on a patient, the paper printout 70 of the test results will provide evidence of the date, time and results of the leak test performed upon the endoscope 22.

The pressure which is selected as the predetermined pressure which, when reached, triggers the de-actuation of the compressor 44 can vary dependent upon the pressure-holding capacities of the instrument to be tested. For example, one would not want the predetermined pressure to be so high that damage to the instrument could result from the leak test operation. However, for commonly-used endoscopes, a test pressure of 200 g/cm² is a suitable predetermined pressure, and that is the pressure level chosen for triggering the de-actuation of the compressor 44 of the depicted apparatus 20.

For use as the preselected period of time (as measured by the timer 82) between the moment that the compressor 44 is de-actuated and the internal pressure of the instrument is collected for computational purposes by the computer means 84, a period of ninety seconds is suitable, and a pressure differential range of 5 g/cm² is suitable as being acceptable pressure differential range for an instrument which passes the leak test. In other words, if an instrument, such as an endoscope, is pressurized to 200 g/cm² at which time the compressor is de-actuated and then the internal pressure of the instrument does not drop below 195 g/cm² over a period of ninety seconds, then that instrument passes the leak test. By comparison, if the internal pressure of the instrument drops below 195 g/cm² over the ninety second period, then that instrument fails the leak test.

If large-enough leaks are present in the endoscope 22 being tested, the internal pressure of the endoscope 22 may never reach the predetermined pressure level, no matter how long the compressor 44 is operated. Accordingly, it is preferable that the control circuitry 60 includes an additional timer 98 which monitors the time from the moment that the compressor operation is initiated and is capable of shutting the compressor 44 OFF if an excessive amount of time passes before the predetermined pressure level of the endoscope is reached. In practice, it has been found that in substantially leak-free endoscopes, the predetermined pressure level is usually attained within about five seconds from the moment that the compressor operation is initiated. Accordingly, the additional timer 98 is adapted to shut the compressor OFF and energize the red “fail” indicator light 90 if the predetermined pressure level is not reached, for example, in seven seconds. If used to shut the compressor 44 OFF, this additional timer 98 can preferably be re-set upon returning the apparatus ON/OFF switch 54 back to the OFF position.

To summarize the operation of the leak test apparatus 20 and assuming that there are no appreciable leaks in the endoscope 22, the internal pressure of the endoscope 22 (which pressure is continually displayed on the LED display 64) is raised by the compressor 44 toward the predetermined pressure level. Upon reaching the predetermined pressure level, the compressor 44 is automatically de-actuated, and the timer 82 begins the timing of a prescribed (test) period of time. At the end of the test period, the internal pressure of the endoscope 22 is collected (by way of the computer means 84) and then subtracted from the internal pressure of the endoscope 22 at the beginning of the test period (i.e. the predetermined pressure level) to compute the resulting pressure differential. If the resulting pressure differential is outside of, or greater than, an acceptable pressure differential (as determined by the comparison circuit 86), then the red light 90 is energized to indicate that the endoscope 22 has failed the leak test, but if the resulting pressure differential is within the acceptable pressure differential (as determined by the comparison circuit 86), then the green light 92 is energized to indicate that the endoscope 22 has passed the leak test.

It follows that the apparatus 20 is advantageous in that its operation is not dependent upon the existence of a liquid basin in which the endoscope 22 being tested is submerged, nor does its operation require monitoring by an operator. Instead and after an endoscope 22 is coupled to the hose 48, the apparatus switch 54 is switched ON, and the endoscope serial number is input into the database 68, an operator can leave the apparatus 20 unattended while it performs its leak test operation. Accordingly, the apparatus 20 is automatic is operation and is labor-saving in nature in that an operator who is responsible for coupling an endoscope 22 to the apparatus 20 and switching the apparatus switch 54 ON is free to perform other tasks while a leak-testing operation is carried out. Furthermore, the printout 70 of the test results provides a convenient written record which can be attached within the record of the patient who is to be worked upon with the endoscope 22 being tested.

It will be understood that numerous modifications and substitutions can be had to the aforedescribed embodiment without departing from the spirit of the invention. For example, although the aforedescribed embodiment 20 has been shown and described as being well-suited for use while the instrument being tested is situated within the open air (i.e. not in a submerged condition), it will be understood that the apparatus 20 can be used to identify the existence and location of any leaks in an instrument which has been submerged within a tank of liquid, such as water. In such an instance, the coupler member 50 is connected to the access port of the instrument being tested, the instrument is submerged within an amount of liquid, and (after switching the apparatus 20 ON and entering the instrument identification information) the operation of the compressor 44 is initiated. At that point, the interior of the instrument being checked begins to be pressurized by the compressor, and the liquid can be observed for bubbles emitting from sites located along the length of the submerged instrument.

Accordingly, the aforedescribed embodiment is intended for the purpose of illustration and not as limitation.

1. An apparatus for leak testing a lumened instrument having a hollow interior comprising:
means for pressurizing the interior of the lumened instrument to be tested;
means for de-actuating the pressurizing means when the internal pressure of the instrument reaches a predetermined internal pressure;
means for computing the difference between the internal pressure of the instrument at the end of a prescribed period of time following the de-actuation of the pressurizing means and at the start of the prescribed period of time wherein the start of the prescribed period of time corresponds with the moment that the pressurizing means is de-actuated;
means for comparing the computed pressure difference with a range of acceptable pressure differentials and determining whether the computed pressure difference is within or outside of the acceptable range; and
means for providing a visual indication of whether the compared difference is within or outside of the acceptable pressure differential range so that an operator can tell by viewing the visual indication means whether the instrument being tested passes or fails the leak test.

2. The apparatus as defined in claim 1 wherein the means for pressurizing includes an electrically-operated compressor.

3. The apparatus as defined in claim 1 wherein the means for de-actuating the pressurizing means includes means for monitoring the internal pressure of the instrument being tested so that when the internal pressure of the instrument reaches the predetermined internal pressure, the monitoring means shuts the pressurizing means off.

4. The apparatus as defined in claim 3 wherein the monitoring means is connected to the comparing means for sending pressure-related information to the comparing means at the end of the predetermined period of time, which pressure-related information corresponds to the internal pressure of the instrument at the end of the predetermined period of time.

5. The apparatus as defined in claim 1 wherein the computing means includes a database containing information relating to the predetermined pressure of the instrument to be tested and means for subtracting the pressure of the instrument at the end of the predetermined period of time with the predetermined pressure to obtain the pressure difference computed by the computing means and which is used by the comparing means during the performance of its comparison operation.

6. The apparatus as defined in claim 1 wherein the means for comparing includes means for generating one signal if the computed pressure difference is within the acceptable pressure differential range and means for generating another signal if the computed pressure difference is outside of the acceptable pressure differential range, and the visual indication means includes a light bulb of one color for receiving the one signal and a light bulb of another color for receiving the another signal.

7. The apparatus as defined in claim 1 further including means for providing a printout of the leak test results at the completion of a leak test operation.

8. The apparatus as defined in 8 further including means for inputing into the printout-providing means identification information relating to the instrument to be tested so that upon completion of a leak test operation, the instrument identification information can be printed out on the printout with the leak test results.

9. The apparatus as defined in claim 8 further including a date and time tracking means for generating signals relating to the date and time of the leak test, and the means for providing a printout of the leak test results is adapted to receive the signals generated by the date and time tracking means so that the date and time of the leak test can be printed on the printout of the leak test results.

10. The apparatus as defined in claim 8 further comprising means for preventing the pressurizing means from being energized unless the identification information relating to the instrument to be tested is input into the printout- providing means.

11. An apparatus for leak testing a lumened instrument having a hollow interior comprising:
means for pressurizing the interior of the lumened instrument to be tested;
means for monitoring the internal pressure of the lumened instrument as the interior of the lumened instrument is being pressurized;
means for de-actuating the pressurizing means when the internal pressure of the instrument reaches a predetermined internal pressure;
means for calculating the actual pressure differential between the internal pressure of the instrument at the moment that the pressurizing means is de-actuated and the internal pressure of the instrument at the end of a prescribed period of time following the de-actuation of the pressurizing means;
a database including information relating to an acceptable pressure differential which, when the actual pressure differential falls within, would indicate that the instrument being tested passes the leak test and which, when the actual pressure differential falls outside of, would indicate that the instrument being tested fails the leak test;
means for comparing the actual pressure differential to the acceptable pressure differential range and determining whether the actual pressure differential falls within or outside of the acceptable range; and
means connected to the comparing means for providing a visual indication of whether the actual pressure differential is within or outside of the acceptable range so that an operator can tell by viewing the visual indication means whether the instrument being tested passes or fails the leak test.

12. The apparatus as defined in claim 11 wherein the monitoring means is connected to the comparing means for sending pressure-related information to the comparing means at the end of the predetermined period of time, which pressure-related information corresponds to the internal pressure of the instrument at the end of the predetermined period of time.

13. The apparatus as defined in claim 11 wherein the calculating means includes means for subtracting the pressure of the instrument at the end of the predetermined period of time with the predetermined pressure to obtain the actual-pressure differential which is used by the comparing means during the performance of its comparison operation.

14. The apparatus as defined in claim 11 wherein the means for comparing includes means for generating one signal if the actual pressure differential is within the acceptable pressure differential range and means for generating another signal if the actual pressure differential is outside of the acceptable pressure differential range, and the visual indication means includes a light bulb of one color for receiving the one signal and a light bulb of another color for receiving the another signal.

15. The apparatus as defined in claim 11 further including means for providing a printout of the leak test results at the completion of a leak test operation.

16. The apparatus as defined in 15 further including means for inputing into the printout-providing means identification information relating to the instrument to be tested so that upon completion of a leak test operation, the instrument identification information can be printed out on the printout with the leak test results.

17. The apparatus as defined in claim 16 further including a date and time tracking means for generating signals relating to the date and time of the leak test, and the means for providing a printout of the leak test results is adapted to receive the signals generated by the date and time tracking means so that the date and time of the leak test can be printed on the printout of the leak test results.

18. The apparatus as defined in claim 16 further comprising means for preventing the pressurizing means from being energized unless the identification information relating to the instrument to be tested is input into the printout- providing means.

19. A method for leak testing a lumened instrument having a hollow interior, the method comprising the steps of:
pressurizing the interior of the lumened instrument to be tested;
discontinuing the pressurizing step when the internal pressure of the instrument reaches a predetermined internal pressure;
computing the difference between the internal pressure of the instrument at the end of a prescribed period of time following the discontinuance of the pressurizing step and at the start of the prescribed period of time wherein the start of the prescribed period of time corresponds with the moment that the pressurizing step is discontinued;
comparing the computed pressure difference with a range of acceptable pressure differentials and determining whether the computed pressure difference is within or outside of the acceptable range; and
providing a visual indication of whether the compared difference is within or outside of the acceptable pressure differential range.

20. The method as defined in claim 19 wherein the step of discontinuing the pressurizing step is preceded by the step of monitoring the internal pressure of the instrument being tested so that when the internal pressure of the instrument reaches the predetermined internal pressure, the pressurizing step is discontinued.

21. The method as defined in claim 19 further comprising a step of providing a printout of the leak test results at the completion of a leak test operation.

22. The method as defined in 21 wherein the step of providing a printout includes a step of printing out identification information relating to the instrument to be tested on the printout with the leak test results.

23. The method as defined in claim 21 wherein the step of providing a printout includes a step of printing out the date and time of the leak test on the printout with the leak test results.

24. The method as defined in claim 22 wherein the step of pressurizing is preceded by a step of recording identification information relating to the instrument to be tested so that unless the step of recording is performed, the step of pressurizing cannot be initiated.
